(19) United States
(12) Patent Application Publication
(10) Pub. No.: US 2005/0112409 A1
(43) Pub. Date: May 26, 2005

(54) Magnetic recording medium

(75) Inventors: Yuichiro Murayama, Kanagawa (JP); Hiroshi Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/969,932

(22) Filed: Oct. 22, 2004

(30) Foreign Application Priority Data
Oct. 23, 2003 (JP) 2003-363304

(51) Int. Cl. G11B 5/714

(52) U.S. Cl. 428/694 BA; 428/694 BU; 428/694 BH

(57) ABSTRACT

A magnetic recording medium is provided that includes a non-magnetic support and at least one magnetic layer provided on or above the non-magnetic support, the magnetic layer containing a ferromagnetic powder dispersed in a binder, the binder containing a polyurethane resin having a bridged hydrocarbon structure or a spiro structure, and the ferromagnetic powder containing an acicular ferromagnetic substance having a major axis length of 20 to 50 nm or a tabular ferromagnetic substance having a plate size of 10 to 50 nm. There is also provided the magnetic recording medium wherein it further includes a non-magnetic layer provided between the non-magnetic support and the magnetic layer, the non-magnetic layer containing a non-magnetic powder dispersed in a binder, and the binder of the non-magnetic layer containing a polyurethane resin having a bridged hydrocarbon structure or a spiro structure.

### BACKGROUND OF THE INVENTION

1. Field of the Invention

The present invention relates to a magnetic recording medium comprising, above a non-magnetic support, at least one magnetic layer in which a ferromagnetic powder and a binder are dispersed.

2. Description of the Related Art

Magnetic recording technology is widely used in various fields including video, audio, and computer applications since the technology has excellent characteristics that cannot be achieved by other recording methods; for example, media can be used repeatedly, systems can be built in combination with peripheral equipment due to the ease of conversion of a signal to electronic form, and signals can be corrected easily.

In general, with the demand for higher recording density of magnetic recording media for computer use, etc., it is necessary to yet further improve electromagnetic conversion characteristics, and it is important to make the ferromagnetic powder finer, the surface of the medium ultra smooth, etc.

With regard to finer magnetic substances, a recent magnetic substance employs a ferromagnetic metal powder of 0.1 μm or less or a ferromagnetic hexagonal ferrite powder. In the case of a multilayer structure in which a magnetic layer is provided as an upper layer above a non-magnetic lower layer provided on the surface of a support, in order to highly disperse in a binder a fine non-magnetic powder used for the non-magnetic layer or the fine magnetic substance, a dispersion technique has been proposed in which the hydrophilic polar group —SO₃M (M denotes hydrogen, an alkali metal, or an ammonium salt) is introduced into the binder, and the binder chain is adsorbed on the magnetic substance or the non-magnetic powder via the polar group so as to achieve a smooth surface.

For example, magnetic recording media employing a binder containing a specified polyurethane have been proposed (ref. JP-A-2003-123222, JP-A-2001-331923, JP-A-2001-331922, JP-A-6-259746, and JP-A-4-67313 (JP-A denotes a Japanese unexamined patent application publication)). However, when these polyurethanes are used as binders, there are the problems that the dispersibility of a ferromagnetic powder is insufficient and adequate electromagnetic conversion characteristics cannot be obtained. Furthermore, there is also the problem that a binder component that is not bonded to the ferromagnetic powder precipitates on the surface of a coating during long term storage, thus affecting the durability.

### BRIEF SUMMARY OF THE INVENTION

It is an object of the present invention to provide a magnetic recording medium having excellent dispersibility, coating smoothness, electromagnetic conversion characteristics, and transport durability.

The object of the present invention can be accomplished by the following (1) to (4).

(1) A magnetic recording medium comprising a non-magnetic support and at least one magnetic layer provided on or above the non-magnetic support, the magnetic layer comprising a ferromagnetic powder dispersed in a binder, the binder comprising a polyurethane resin having a bridged hydrocarbon structure or a spiro structure, and the ferromagnetic powder comprising an acicular ferromagnetic substance having a major axis length of 20 to 50 nm or a tabular ferromagnetic substance having a plate size of 10 to 50 nm.

(2) A magnetic recording medium comprising a non-magnetic support, at least one non-magnetic layer provided over the non-magnetic support, and at least one magnetic layer provided over the non-magnetic layer, the non-magnetic layer comprising a non-magnetic powder dispersed in a binder, the magnetic layer comprising a ferromagnetic powder dispersed in a binder, the binder of the non-magnetic layer and/or the binder of the magnetic layer comprising a polyurethane resin having a bridged hydrocarbon structure or a spiro structure, and the ferromagnetic powder comprising an acicular ferromagnetic substance having a major axis length of 20 to 50 nm or a tabular ferromagnetic substance having a plate size of 10 to 50 nm.

(3) The magnetic recording medium according to (1), wherein the content of the bridged hydrocarbon structure or spiro structure in the polyurethane resin is 1 to 5.5 mmol/g.

(4) The magnetic recording medium according to (1), wherein the bridged hydrocarbon structure or the spiro structure is at least one structure selected from the group consisting of Formulae (1) to (3).

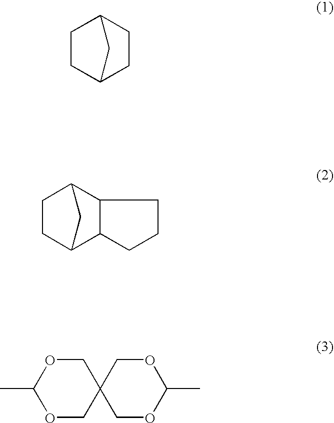

In accordance with the present invention, it is possible to obtain a magnetic recording medium having improved electromagnetic conversion characteristics and repetitive transport durability, and reduced deterioration of durability after storage.

### DETAILED DESCRIPTION OF THE INVENTION

The present invention relates to a magnetic recording medium comprising, on or above a non-magnetic support, at least one magnetic layer in which a ferromagnetic powder and a binder are dispersed, the binder comprising a polyurethane resin having a bridged hydrocarbon structure or a spiro structure, and the ferromagnetic powder comprising an acicular ferromagnetic substance having a major axis length of 20 to 50 nm or a tabular ferromagnetic substance having a plate size of 10 to 50 nm.

Use of a magnetic substance in the form of fine particles as the ferromagnetic powder enables excellent long-term storage stability to be exhibited. This is due to an increase in adsorption of the binder onto the magnetic substance because the surface area per unit weight of the magnetic substance is increased accompanying use of the magnetic substance in the form of fine particles. It is surmised that, by decreasing the amount of unadsorbed binder component, it is possible to prevent the free binder component from precipitating on the surface of a coating during long-term storage and thus affecting the durability. In particular, there is excellent long-term storage stability at a high temperature, where molecular mobility of the binder is high.

Furthermore, the present invention can exhibit the same effects by adding a spiro structure or an alicyclic bridged hydrocarbon structure to a polyol structure such as a polyester polyol, a polyether polyol, or a polycarbonate polyol, and also by adding the same structure to a short chain diol, which is used as a chain extending agent, or an organic diisocyanate component.

In particular, by using as the short chain diol component an alicyclic polycyclic diol such as tricyclodecane dimethanol or spiroglycol, a bulky polycyclic skeleton can be introduced into the vicinity of a urethane bond, thereby preventing association between urethane groups in solution by virtue of steric hindrance. That is, the solubility of the polyurethane in a solvent can be increased, thus improving the dispersibility of the ferromagnetic powder.

In particular, sufficient dispersibility can be obtained in a system employing a magnetic substance such as an acicular ferromagnetic substance having a short major axis length or a tabular ferromagnetic substance having a small plate size, which are finer than conventional magnetic substances and are difficult to disperse.

Furthermore, the use of such a structure enables the glass transition temperature (Tg) of the polyurethane to be increased and, in particular, excellent coating durability at high temperature can be also exhibited. In particular, adequate mechanical strength of a magnetic layer coating can be obtained even with a magnetic substance in the form of fine particles. This is due to the above-mentioned effect of highly dispersing the magnetic substance and an improvement in the strength because of the presence of a polycyclic skeleton.

I. Magnetic Layer

The magnetic recording medium of the present invention includes a magnetic layer comprising a binder containing a polyurethane resin having a bridged hydrocarbon structure or a spiro structure and an acicular ferromagnetic substance having a major axis length of 20 to 50 nm or a tabular ferromagnetic substance having a plate size of 10 to 50 nm.

(1) Binder

The magnetic recording medium of the present invention employs a binder containing a polyurethane resin having a bridged hydrocarbon structure or a spiro structure.

The ‘bridged hydrocarbon structure’ referred to in the present invention means an aliphatic hydrocarbon skeleton having a plurality of rings that share at least two atoms. The ‘spiro skeleton’ referred to here means a structure in which a plurality of rings share one atom.

With regard to the bridged hydrocarbon structure or the spiro structure, it is preferably at least one structure selected from the group consisting of Formulae (1) to (3).

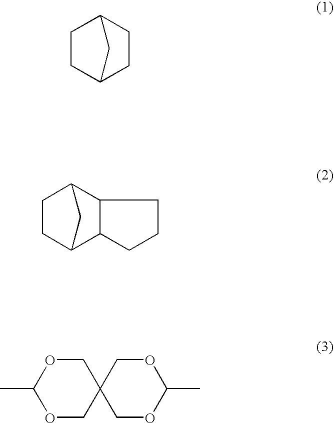

The bridged hydrocarbon structure or the spiro structure in the polyurethane resin can be introduced from a diol component within a polyol component, a short chain diol component as a chain extending agent, or an organic diisocyanate component.

With regard to a polyol component having a bridged hydrocarbon structure or a spiro structure, there can be cited as examples a polyester polyol, a polyether polyol, and a polycarbonate polyol obtained using a short chain diol having the bridged hydrocarbon structure or the spiro structure.

Specific examples of the short chain diol having a bridged hydrocarbon structure include the compounds below.

Bicyclo[1.1.0]butanediol, bicyclo[1.1.1]pentanediol, bicyclo[2.1.0]pentanediol, bicyclo[2.1.1]hexanediol, bicyclo[3.1.0]hexanediol, bicyclo[2.2.1]heptanediol, bicyclo[3.2.0]heptanediol, bicyclo[3.1.1]heptanediol, bicyclo[2.2.2]octanediol, bicyclo[3.2.1]octanediol, bicyclo[4.2.0]octanediol, bicyclo[5.2.0]nonanediol, bicyclo[3.3.1]nonanediol, bicyclo[3.3.2]decanediol, bicyclo[4.2.2]decanediol, bicyclo[4.3.3]dodecanediol, bicyclo[3.3.3]undecanediol, bicyclo[1.1.0]butane dimethanol, bicyclo[1.1.1]pentane dimethanol, bicyclo[2.1.0]pentane dimethanol, bicyclo[2.1.1]hexane dimethanol, bicyclo[3.1.0]hexane dimethanol, bicyclo[2.2.1]heptane dimethanol, bicyclo[3.2.0]heptane dimethanol, bicyclo[3.1.1]heptane dimethanol, bicyclo[2.2.2]octane dimethanol, bicyclo[3.2.1]octane dimethanol, bicyclo[4.2.0]octane dimethanol, bicyclo[5.2.0]nonane dimethanol, bicyclo[3.3.1]nonane dimethanol, bicyclo[3.3.2]decane dimethanol, bicyclo[4.2.2]decane dimethanol, bicyclo[4.3.3]dodecane dimethanol, bicyclo[3.3.3]undecane dimethanol, tricyclo[2.2.1.0]heptanediol, tricyclo[5.2.1.0^{2,6}]decanediol, tricyclo[4.2.1.2^{7,9}]undecanediol, tricyclo[5.4.0.0^{2,9}]undecanediol, tricyclo[5.3.1.1]dodecanediol, tricyclo[4.4.1.1]dodecanediol, tricyclo[7.3.2.0^{5,13}]tetradecanediol, tricyclo[5.5.1.0^{3,11}]tridecanediol, tricyclo[2.2.1.0]heptane dimethanol, tricyclo[5.2.1.0^{2,6}]decane dimethanol, tricyclo[4.2.1.2^{7,9}]undecane dimethanol, tricyclo[5.4.0.0^{2,9}]undecane dimethanol, tricyclo[5.3.1.1]dodecane dimethanol, tricyclo[4.4.1.1]dodecane dimethanol, tricyclo[7.3.2.0^{5,13}]tetradecane dimethanol, and tricyclo[5.5.1.0^{3,11}]tridecane dimethanol.

Specific examples of the short chain diol having a spiro structure include the compounds below.

Spiro[3,4]octane dimethanol, spiro[3,4]heptane dimethanol, spiro[3,4]decane dimethanol, dispiro[5,1,7,2]heptadecane dimethanol, cyclopentane spirocyclobutane dimethanol, cyclohexane spirocyclopentane dimethanol, spirobicyclohexane dimethanol, and bis(1,1-dimethyl-2-hydroxyethyl)-2,4,8,10-tetraoxaspiro[5,5]undecane. Among these, bis(1,1-dimethyl-2-hydroxyethyl)-2,4,8,10-tetraoxaspiro[5,5]undecane is preferable.

With regard to the polyol component having a bridged hydrocarbon structure or a spiro structure, a polyester polyol from tricyclo[5.2.1.0^{2,6}]decane dimethanol, a polyether polyol that is a propylene oxide adduct of tricyclo[5.2.1.0^{2,6}]decane dimethanol, and a polycarbonate polyol from tricyclo[5.2.1.0^{2,6}]decane dimethanol are preferable.

As a dibasic acid component of the polyester polyol, a known dibasic acid can be used. Examples of the dibasic acid include isophthalic acid, terephthalic acid, naphthalenedicarboxylic acid, succinic acid, adipic acid, azelaic acid, sebacic acid, malonic acid, glutaric acid, pimelic acid, and suberic acid. Among these, succinic acid, adipic acid, and sebacic acid are preferable.

The polyether polyol and the polycarbonate polyol may also be copolymerized with a known short chain diol other than the above-mentioned short chain diols having a bridged hydrocarbon structure or a spiro structure.

Examples of the short chain diol that can be used in combination includes those below.

Aliphatic straight-chain diols such as 1,3-propanediol, 1,4-butanediol, 1,5-pentanediol, and 1,6-hexanediol.

Aliphatic diols having a branched side chain such as 2,2-dimethyl-1,3-propanediol, 3,3-dimethyl-1,5-pentanediol, 2-methyl-2-ethyl-1,3-propanediol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,5-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristyl-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, and 5-butyl-1,9-nonanediol.

Diols having a cyclic structure such as bisphenol A, and hydrogenated bisphenol A.

It is also possible to use as a chain extending agent the above-mentioned short chain diol having a bridged hydrocarbon structure or a spiro structure. It is preferable to use tricyclo[2.2.1.0]heptane dimethanol, tricyclo[5.2.1.0^{2,6}]decane dimethanol, bicyclo[3.3.2]decane dimethanol, bicyclo[4.2.2]decane dimethanol, spiro[3,4]decane dimethanol, or bis(1,1-dimethyl-2-hydroxyethyl)-2,4,8,10-tetraoxaspiro[5,5]undecane, and particularly preferably tricyclo[5.2.1.0^{2,6}]decane dimethanol or bis(1,1-dimethyl-2-hydroxyethyl)-2,4,8,10-tetraoxaspiro[5,5]undecane.

Specific examples of the diisocyanate having a bridged hydrocarbon structure or a spiro structure include those below.

Tricyclo[2.2.1.0]heptane diisocyanate, tricyclo[5.2.1.0^{2,6}]decane diisocyanate, tricyclo[4.2.1.2^{7,9}]undecane diisocyanate, tricyclo[5.4.0.0^{2,9}]undecane diisocyanate, tricyclo[5.3.1.1]dodecane diisocyanate, tricyclo[4.4.1.1]dodecane diisocyanate, tricyclo[7.3.2.0^{5,13}]tetradecane diisocyanate, tricyclo[5.5.1.0^{3,11}]tridecane diisocyanate, norbornane diisocyanate, spiro[3,4]octane diisocyanate, spiro[3,4]heptane diisocyanate, spiro[3,4]decane diisocyanate, dispiro[5,1,7,2]heptadecane diisocyanate, cyclopentane spirocyclobutane diisocyanate, cyclohexane spirocyclopentane diisocyanate, and spirobicyclohexane diisocyanate.

Preferred examples include tricyclo[5.2.1.0^{2,6}]decane diisocyanate and norbornane diisocyanate.

As the diisocyanate component that is used in combination with the polyol having a bridged hydrocarbon structure or a spiro structure, or the short chain diol having a bridged hydrocarbon structure, known compounds are used. TDI (tolylene diisocyanate), MDI (diphenylmethane diisocyanate), p-phenylene diisocyanate, o-phenylene diisocyanate, m-phenylene diisocyanate, xylylene diisocyanate, hydrogenated xylylene diisocyanate, isophorone diisocyanate, etc. are preferable.

The content of the bridged hydrocarbon structure or the spiro structure in the polyurethane is preferably 1 to 5.5 mmol/g. When it is in this range, the durability and the smoothness are good.

The concentration of the urethane group is preferably 2.0 mmol/g to 6.0 mmol/g, and more preferably 2.5 mmol/g to 5.5 mmol/g. It is preferable for it to be in such a range since the glass transition temperature (Tg) of the coating does not decrease, and good durability can be obtained. Furthermore, it is preferable since the solvent solubility can be guaranteed and the dispersibility therefore does not deteriorate. Since a polyol can be added if the dispersibility does not deteriorate, this is synthetically advantageous because the molecular weight, etc. is easily controlled.

The weight-average molecular weight of the polyurethane is preferably 40,000 to 100,000, and more preferably 50,000 to 90,000. When it is in such a range, since the coating strength does not deteriorate, the durability improves. Furthermore, since the solvent solubility does not deteriorate, the dispersibility improves.

The glass transition temperature (Tg) of the polyurethane is preferably 40° C. to 200° C., more preferably 70° C. to 180° C, and yet more preferably 80° C. to 170° C. When it is in such a range, since the coating strength at a high temperature does not deteriorate, the durability and the storage stability improve. Furthermore, the calender molding characteristics are excellent, and the electromagnetic conversion characteristics improve.

The polyurethane used in the present invention may contain a polar group. As the polar group, —SO₃M, —OSO₃M, —PO₃M₂, and —COOM are preferable. Among these, —SO₃M and —OSO₃M are more preferable. M denotes a hydrogen atom, an alkali metal, or ammonium. The content of the polar group in the polyurethane is preferably 1×10⁻⁵ eq/g to 5×10⁻⁴ eq/g. When the polar group content is in the above-mentioned range, since there is sufficient adsorption onto the magnetic substance and solvent solubility, the dispersibility improves.

The polyurethane resin may contain an OH group. There are preferably 2 to 20 OH groups per molecule, and more preferably 3 to 15. It is preferable if the number of OH groups is in such a range, since the reactivity with an isocyanate curing agent is good, a desirable coating strength can be obtained, and the durability improves.

(2) Ferromagnetic Powder

The magnetic recording medium of the present invention employs an acicular ferromagnetic substance having a major axis length of 20 to 50 nm or a tabular ferromagnetic substance having a plate size of 10 to 50 nm.

(a) Acicular Ferromagnetic Substance

The acicular ferromagnetic substance used in the magnetic recording medium of the present invention is preferably a ferromagnetic metal powder. The ferromagnetic metal powder is more preferably a cobalt-containing ferromagnetic iron oxide or a cobalt-containing ferromagnetic alloy powder.

The specific surface area of the ferromagnetic metal powder by the BET method (S_{BET}) is preferably 40 to 80 m²/g, and more preferably 50 to 70 m²/g. The crystallite size is preferably 12 to 25 nm, more preferably 13 to 22 nm, and particularly preferably 14 to 20 nm. The major axis length is 20 to 50 nm, preferably at least 20 nm but less than 50 nm, and more preferably 20 to 40 nm.

Examples of the ferromagnetic metal powder include yttrium-containing Fe, Fe—Co, Fe—Ni, and Co—Ni—Fe, and the yttrium content in the ferromagnetic metal powder is preferably 0.5 atom % to 20 atom % as the yttrium atom/Fe atom ratio Y/Fe, and more preferably 5 to 10 atom %. It is preferable if it is in such a range since it is possible to obtain good saturation magnetization for the ferromagnetic metal powder, and the magnetic properties are improved. Since the iron content is high, the magnetic properties are good, and this is preferable since good electromagnetic conversion characteristics are obtained. Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

One example of a process for producing the ferromagnetic metal powder used in the present invention, into which cobalt or yttrium has been introduced, is illustrated below.

For example, an iron oxyhydroxide obtained by blowing an oxidizing gas into an aqueous suspension in which a ferrous salt and an alkali have been mixed can be used as a starting material.

This iron oxyhydroxide is preferably of the α-FeOOH type, and with regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain a Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable.

In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

Neodymium, samarium, praseodymium, lanthanum, gadolinium, etc. can be introduced into the ferromagnetic metal powder of the present invention as well as yttrium. They can be introduced using a chloride such as yttrium chloride, neodymium chloride, samarium chloride, praseodymium chloride, or lanthanum chloride or a nitrate salt such as neodymium nitrate or gadolinium nitrate, and they can be used in a combination of two or more types.

The coercive force (Hc) of the ferromagnetic metal powder is preferably 159.2 to 238.8 kA/m (2,000 to 3,000 Oe), and more preferably 167.2 to 230.8 kA/m (2,100 to 2,900 Oe).

The saturation magnetic flux density is preferably 150 to 300 mT (1,500 to 3,000 G), and more preferably 160 to 290 mT (1,600 to 2,900 G). The saturation magnetization (σs) is preferably 140 to 170 A·m²/kg (140 to 170 emu/g), and more preferably 145 to 160 A·m²/kg (145 to 160 emu/g).

The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there are a technique of improving the particle distribution of goethite, a technique of using monodispersed α-Fe₂O₃, and a technique of preventing sintering between particles, etc. in the ferromagnetic metal powder.

(b) Tabular Ferromagnetic Substance

The tabular ferromagnetic substance that can be used in the present invention has a plate size of 10 to 50 nm.

The tabular ferromagnetic substance is preferably a ferromagnetic hexagonal ferrite powder.

Examples of the ferromagnetic hexagonal ferrite include substitution products of barium ferrite, strontium ferrite, lead ferrite, and calcium ferrite, and Co substitution products. More specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. In addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr may be included. In general, those to which Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is 10 to 50 nm as a hexagonal plate size, preferably 15 to 45 nm, and more preferably 20 to 35 nm. When a magnetoresistive head is used for playback, the plate size is preferably 40 nm or smaller so as to reduce noise. It is preferable if the plate size is in such a range, since stable magnetization can be expected due to the absence of thermal fluctuations. Furthermore, noise is reduced and it is suitable for high density magnetic recording.

The tabular ratio (plate size/plate thickness) is preferably 1 to 15, and more preferably 2 to 7. When it is in such a range, adequate orientation can be obtained, and noise decreases due to an absence of inter-particle stacking. The S_{BET} of a powder having a particle size within this range is usually 10 to 200 m²/g. The specific surface area substantially coincides with the value obtained by calculation using the plate size and the plate thickness. The crystallite size is preferably 50 to 450 Å, and more preferably 100 to 350 Å. In general, the plate size and the plate thickness distributions are preferably as narrow as possible. Although it is difficult, the distribution can be expressed using a numerical value by randomly measuring 500 particles on a TEM photograph of the particles. The distribution is not a normal distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the tabular ferromagnetic substance can be adjusted so as to be on the order of 39.8 to 398 kA/m (500 to 5,000 Oe). A higher Hc is advantageous for high-density recording, but it is restricted by the capacity of the recording head. It is usually on the order of 63.7 to 318.4 kA/m (800 to 4,000 Oe), but is preferably 119.4 to 278.6 kA/m (1,500 to 3,500 Oe). When the saturation magnetization of the head exceeds 1.4 T, it is preferably 159.2 kA/m (2,000 Oe) or higher.

The Hc can be controlled by the particle size (plate size, plate thickness), the type and amount of element included, the element replacement sites, the conditions used for the particle formation reaction, etc. The saturation magnetization (σs) is preferably 40 to 80 A·m²/kg (40 to 80 emu/g). A higher as is preferable, but there is a tendency for it to become lower when the particles become finer. In order to improve the σs, making a composite of magnetoplumbite ferrite with spinel ferrite, selecting the types of element included and their amount, etc. are well known. It is also possible to use a W type hexagonal ferrite.

With regard to a production method for the ferromagnetic hexagonal ferrite, there is glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder; hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; co-precipitation method (3) in which a barium ferrite composition metal salt solution is neutralized with an alkali, and after a by-product is removed, it is dried and treated at 1100° C. or less, and ground to give a barium ferrite crystal powder, etc., but any production method can be used in the present invention.

When dispersing the magnetic substance, the surface of the magnetic particles can be treated with a material that is compatible with a dispersing medium and the polymer. With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance. The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the magnetic recording medium. The moisture contained in the magnetic substance also influences the dispersion. Although the optimum value depends on the dispersing medium and the polymer, it is usually 0.01% to 2.0%.

The magnetic layer of the present invention can contain an additive as necessary. Examples of the additive include an abrasive, a lubricant, a dispersant/dispersion adjuvant, a fungicide, an antistatic agent, an antioxidant, a solvent, and carbon black.

Examples of these additives include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, linolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid, or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing).

These dispersants, lubricants, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd), Enujelv OL (produced by New Japan Chemical Co., Ltd.), TA-3 (produced by Shin-Etsu Chemical Industry Co., Ltd.), Armide P (produced by Lion Armour), Duomin TDO (produced by Lion Corporation), BA41G (produced by The Nisshin Oil Mills, Ltd.), Profan 2012E, Newpol PE 61, and lonet MS400 (produced by Sanyo Chemical Industries, Ltd.).

An organic solvent used for the magnetic layer of the present invention can be a known organic solvent. As the organic solvent, tetrahydrofuran, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, cresol, or chlorobenzene, a chlorohydrocarbon such as methylene chloride, ethylene chloride, carbon tetrachloride, chloroform, ethylene chlorohydrin, or dichlorobenzene, N,N-dimethylformamide, hexane, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and the non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the upper layer solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

These dispersants, lubricants, and surfactants used in the magnetic layer of the present invention may be selected as necessary in terms of the type and amount according to the magnetic layer and a non-magnetic layer, which will be described later. For example, although these examples should not be construed as being limited thereto, the dispersant has the property of adsorbing or bonding via its polar group, and it is adsorbed on or bonds to the surface of mainly the ferromagnetic powder in the magnetic layer and the surface of mainly a non-magnetic powder in the non-magnetic layer, which will be described later, via the polar group; it is surmised that once an organophosphorus compound has been adsorbed on the surface of a metal, a metal compound, etc. it is difficult for it to desorb. In the present invention, the surface of the ferromagnetic powder or the surface of the non-magnetic powder is therefore covered with an alkyl group, an aromatic group, etc., the affinity of the ferromagnetic pawder or the non-magnetic powder toward the binder resin component increases, and the dispersion stability of the ferromagnetic powder or the non-magnetic powder is also improved. Furthermore, with regard to the lubricant, since it is present in a free state, it is surmised that by using fatty acids having different melting points in the non-magnetic layer and the magnetic layer exudation onto the surface is controlled, by using esters having different boiling points or polarity exudation onto the surface is controlled, by adjusting the amount of surfactant the coating stability is improved, and by increasing the amount of lubricant added to the non-magnetic layer the lubrication effect is improved. All or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

The magnetic layer of the present invention can contain as necessary carbon black.

Types of carbon black that can be used include furnace black for rubber, thermal black for rubber, black for coloring, and acetylene black. The carbon black used in each layer should have characteristics that have been optimized as follows according to a desired effect, and the effect can be obtained by the combined use thereof.

The specific surface area of the carbon black is preferably 100 to 500 m²/g, and more preferably 150 to 400 m²/g, and the oil absorption with dibutyl phthalate (DBP oil absorption) is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, MA-600, MA-230, #4000 and #4010 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured -by Columbian Carbon Co.), and Ketjen Black EC (manufactured by Akzo Nobel).

The carbon black may be subjected to any of a surface treatment with a dispersant, etc., grafting with a resin, or a partial surface graphitization. The carbon black may also be dispersed in a binder prior to addition to a coating solution. The carbon black that can be used in the present invention can be selected by referring to, for example, the ‘Kabon Burakku Binran (Carbon Black Handbook)’ (edited by the Carbon Black Association of Japan).

The carbon black may be used singly or in a combination of different types thereof. When the carbon black is used, it is preferably used in an amount of 0.1 to 30 wt % based on the weight of the magnetic substance. The carbon black has the functions of preventing static charging of the magnetic layer, reducing the coefficient of friction, imparting light-shielding properties, and improving the film strength. Such functions vary depending upon the type of carbon black. Accordingly, it is of course possible in the present invention to appropriately choose the type, the amount and the combination of carbon black for the magnetic layer according to the intended purpose on the basis of the above mentioned various properties such as the particle size, the oil absorption, the electrical conductivity, and the pH value, and it is better if they are optimized for the respective layers.

II. Non-magnetic Layer

The magnetic recording medium of the present invention may have at least one non-magnetic layer between a non-magnetic support and the magnetic layer, the non-magnetic layer having dispersed therein a non-magnetic powder and a binder. When the non-magnetic layer is present, it is preferable to use, as the binder for the non-magnetic layer, the same binder as that used in the magnetic layer. That is, the binder used for the non-magnetic layer preferably contains a polyurethane resin having a bridged hydrocarbon structure or a spiro structure, which is used in the magnetic layer.

(1) Non-Magnetic Powder

The non-magnetic layer-may employ a magnetic powder as long as the non-magnetic layer is substantially non-magnetic, but preferably employs a non-magnetic powder.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide.

Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-Iron oxide or a titanium oxide is preferable.

The form of the non-magnetic powder may be any one of acicular, spherical, polyhedral, and tabular.

The crystallite size of the non-magnetic powder is preferably 4 nm to 1 μm, and more preferably 40 to 100 nm. When the crystallite size is in the range of 4 nm to 1 μm, there are no problems with dispersion and a suitable surface roughness is obtained.

The average particle size of these non-magnetic powders is preferably 5 nm to 2 μm, but it is possible to combine non-magnetic powders having different average particle sizes as necessary, or widen the particle size distribution of a single non-magnetic powder, thus producing the same effect. The average particle size of the non-magnetic powder is particularly preferably 10 to 200 nm. It is preferable if it is in the range of 5 nm to 2 μm, since good dispersibility and a suitable surface roughness can be obtained.

The specific surface area of the non-magnetic powder is preferably 1 to 100 m²/g, more preferably 5 to 70 m²/g, and yet more preferably 10 to 65 m²/g. It is preferable if the specific surface area is in the range of 1 to 100 m²/g, since a suitable surface roughness can be obtained, and dispersion can be carried out using a desired amount of binder.

The DBP oil absorption is preferably 5 to 100 mL/100 g, more preferably 10 to 80 mL/100 g, and yet more preferably 20 to 60 mL/100 g.

The specific gravity is preferably 1 to 12, and more preferably 3 to 6. The tap density is preferably 0.05 to 2 g/mL, and more preferably 0.2 to 1.5 g/mL. When the tap density is in the range of 0.05 to 2 g/mL, there is little scattering of particles, the operation is easy, and there tends to be little sticking to equipment.

The pH of the non-magnetic powder is preferably 2 to 11, and particularly preferably 6 to 9. When the pH is in the range of 2 to 11, the coefficient of friction does not increase as a result of high temperature and high humidity or release of a fatty acid.

The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. When the Mohs hardness is in the range of 4 to 10, it is possible to guarantee the durability. The amount of stearic acid absorbed by the non-magnetic powder is preferably 1 to 20 μmol/m², and more preferably 2 to 15 μmol/m².

The heat of wetting of the non-magnetic powder in water at 25° C. is preferably in the range of 20 to 60 μJ/cm² (200 to 600 erg/cm²). It is possible to use a solvent that gives a heat of wetting in this range. The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa.

The surface-treated layer may be formed as a porous layer depending on the intended purpose, but it is generally preferable for it to be uniform and dense.

Specific examples of the non-magnetic powder used in the non-magnetic layer of the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, and SN-100, MJ-7, α-iron oxide E270, E271, and E300 (manufactured by Ishihara Sangyo Kaisha Ltd.), titanium oxide STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO2P25 (manufactured by Nippon Aerosil Co., Ltd.), 100A, and 500A (manufactured by Ube Indtistries, Ltd.), Y-LOP (manufactured by Titan Kogyo Kabushiki Kaisha), and calcined products thereof. Particularly preferred non-magnetic powders are titanium dioxide and α-iron oxide.

By mixing carbon black with the non-magnetic powder, the surface electrical resistance of the non-magnetic layer can be reduced, the light transmittance can be decreased, and a desired μVickers hardness can be obtained. The μVickers hardness of the non-magnetic layer is usually 25 to 60 kg/mm², and is preferably 30 to 50 kg/mm² in order to adjust the head contact, and can be measured using a thin film hardness meter (HMA400 manufactured by NEC Corporation) with, as an indentor tip, a triangular pyramidal diamond needle having a tip angle of 80° and a tip radius of 0.1 μm. The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer of the present invention is preferably;100 to 500 m²/g, and more preferably 150 to 400 m²/g, and the DBP oil absorption thereof is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black that can be used in the non-magnetic layer of the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo Nobel).

The carbon black may be surface treated using a dispersant or grafted with a resin, or part of the surface thereof may be converted into graphite. Prior to adding carbon black to a coating solution, the carbon black may be predispersed with a binder. The carbon black is preferably used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Binran’ (Carbon Black Handbook) (edited by the Carbon Black Association of Japan).

It is also possible to add an organic powder to the non-magnetic layer, depending on the intended purpose. Examples of such an organic powder include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used. Production methods such as those described in JP-A-62-18564 and JP-A-60-255827 can be used.

As a binder resin, lubricant, dispersant, additive, solvent, dispersing method, etc. for the non-magnetic layer, those for the magnetic layer can be employed. In particular, the amount and type of binder, and the amounts and types of additive and dispersant can be determined according to known techniques regarding the magnetic layer.

III. Non-Magnetic Support

With regard to the non-magnetic support that can be used in the present invention, known biaxially stretched films such as polyethylene terephthalate, polyethylene naphthalate, polyamide, polyamideimide, and aromatic polyamide can be used. Polyethylene terephthalate, polyethylene naphthalate, and polyamide are preferred.

These supports can be subjected in advance to a corona discharge treatment, a plasma treatment, a treatment for enhancing adhesion, a thermal treatment, etc. The non-magnetic support that can be used in the present invention preferably has a surface smoothness such that its center plane average roughness Ra is in the range of 3 to 10 nm for a cutoff value of 0.25 mm. In the present invention, “center plane average roughness” has the same meaning as “center plane average surface roughness” or “surface center plane average roughness”.

IV. Smoothing Layer

The magnetic recording medium of the present invention may be provided with a smoothing layer. The smoothing layer referred to here is a layer for burying projections on the surface of the non-magnetic support; it is provided between the non-magnetic support and the magnetic layer when the magnetic recording medium is provided with the magnetic layer on the non-magnetic support, and it is provided between the non-magnetic support and the non-magnetic layer when the magnetic recording medium is provided with the non-magnetic layer and the magnetic layer in that order on the non-magnetic support.

The smoothing layer can be formed by curing a radiation curable compound by exposure to radiation. The radiation curable compound referred to here is a compound having the property of polymerizing or crosslinking when irradiated with radiation such as ultraviolet rays or an electron beam, thus increasing the molecular weight and carrying out curing.

V. Backcoat Layer

In general, there is a strong requirement for magnetic tapes for recording computer data to have better repetitive transport properties than video tapes and audio tapes. In order to maintain such high storage stability, a backcoat layer can be provided on the surface of the non-magnetic support opposite to the surface where the non-magnetic layer and the magnetic layer are provided. As a coating solution for the backcoat layer, a binder and a particulate component such as an abrasive or an antistatic agent are dispersed in an organic solvent. As a granular component, various types of inorganic pigment or carbon black can be used. As the binder, a resin such as nitrocellulose, a phenoxy resin, a vinyl chloride resin, or a polyurethane can be used singly or in combination.

VI. Layer Arrangement

In the constitution of the magnetic recording medium used in the present invention, the thickness of the smoothing layer is preferably in the range of 0.3 to 1.0 μm. The thickness of the non-magnetic support is preferably 3 to 80 μm. When the undercoat layer is provided between the non-magnetic support and the non-magnetic layer or the magnetic layer, the thickness of the undercoat layer is preferably 0.01 to 0.8 μm, and more preferably 0.02 to 0.6 μm. The thickness of the backcoat layer provided on the surface of the non-magnetic support opposite to the surface where the non-magnetic layer and the magnetic layer are provided is preferably 0.1 to 1.0 μm, and more preferably 0.2 to 0.8 μm.

The thickness of the magnetic layer is optimized according to the saturation magnetization and the head gap of the magnetic head and the bandwidth of the recording signal, but it is preferably 0.01 to 0.10 μm, more preferably at least 0.02 to 0.08 μm, and yet more preferably 0.03 to 0.08 μm. The percentage variation in thickness of the magnetic layer is preferably ±50% or less, and more preferably ±40% or less. The magnetic layer can be at least one layer, but it is also possible to provide two or more separate layers having different magnetic properties, and a known configuration for a multilayer magnetic layer can be employed.

The thickness of the non-magnetic layer of the present invention is preferably 0.2 to 3.0 μm, more preferably 0.3 to 2.5 μm, and yet more preferably 0.4 to 2.0 μm. The non-magnetic layer of the magnetic recording medium of the present invention exhibits its effect if it is substantially non-magnetic, but even if it contains a small amount of a magnetic substance as an impurity or intentionally, if the effects of the present invention are exhibited the constitution can be considered to be substantially the same as that of the magnetic recording medium of the present invention. ‘Substantially the same’ referred to here means that the non-magnetic layer has a residual magnetic flux density of 10 mT (100 G) or less or a coercive force of 7.96 kA/m (100 Oe) or less, and preferably has no residual magnetic flux density and no coercive force.

VlI. Production Method

A process for producing a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages. All materials, including the ferromagnetic hexagonal ferrite powder, the ferromagnetic metal powder, the non-magnetic powder, the binder, the carbon black, the abrasive, the antistatic agent, the lubricant, and the solvent used in the present invention may be added in any step from the beginning or during the course of the step. The addition of each material may be divided across two or more steps. For example, a polyurethane can be divided and added in a kneading step, a dispersing step, and a blending step for adjusting the viscosity after dispersion. To attain the object of the present invention, a conventionally known production technique may be employed as a part of the steps. In the kneading step, it is preferable to use a powerful kneading machine such as an open kneader, a continuous kneader, a pressure kneader, or an extruder. When a kneader is used, all or a part of the binder (preferably 30 wt % or above of the entire binder) is preferably kneaded with the magnetic powder or the non-magnetic powder at 15 to 500 parts by weight of the binder relative to 100 parts by weight of the magnetic substance. Details of these kneading treatments are described in JP-A-1-106338 and JP-A-1-79274. For the dispersion of the magnetic layer solution and a non-magnetic layer solution, glass beads can be used. As such glass beads, a dispersing medium having a high specific gravity such as zirconia beads, titania beads, or steel beads is suitably used. An optimal particle size and packing density of these dispersing media is used. A known disperser can be used.

The process for producing the magnetic recording medium of the present invention includes, for example, coating the surface of a moving non-magnetic support with a magnetic layer coating solution so as to give a predetermined coating thickness. A plurality of magnetic layer coating solutions can be applied successively or simultaneously in multilayer coating, and a lower magnetic layer coating solution and an upper magnetic layer coating solution can also be applied successively or simultaneously in multilayer coating. As coating equipment for applying the above-mentioned magnetic layer coating solution or the lower magnetic layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a ferromagnetic metal powder, in general, in-plane two-dimensional random is preferable, but it can be three-dimensional random by introducing a vertical component. In the case of a ferromagnetic hexagonal ferrite powder, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 to 1,000 m/min and the temperature of drying air to be 60° C. or higher, and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to treat with metal rolls. The magnetic recording medium of the present invention preferably has a center plane average roughness in the range of 0.1 to 4.0 nm for a cutoff value of 0.25 mm, and more preferably 0.5 to 3.0 nm, which is extremely smooth. As a method therefor, a magnetic layer formed by selecting a specific ferromagnetic powder and binder as described above is subjected to the above-mentioned calendering treatment. With regard to calendering conditions, the calender roll temperature is preferably in the range of 60° C. to 100° C., more preferably in the range of 70° C. to 100° C., and particularly preferably in the range of 80° C. to 100° C., and the pressure is preferably in the range of 100 to 500 kg/cm, more preferably in the range of 200 to 450 kg/cm, and particularly preferably in the range of 300 to 400 kg/cm.

As thermal shrinkage reducing means, there is a method in which a web is thermally treated while handling it with low tension, and a method (thermal treatment) involving thermal treatment of a tape when it is in a layered configuration such as in bulk or installed in a cassette, and either can be used. In the former method, the effect of the imprint of projections of the surface of the backcoat layer is small, but the thermal shrinkage cannot be greatly reduced. On the other hand, the latter thermal treatment can improve the thermal shrinkage greatly, but since the effect of the imprint of projections of the surface of the backcoat layer is strong, the surface of the magnetic layer is roughened, and this causes the output to decrease and the noise to increase. In particular, a high output and low noise magnetic recording medium can be obtained from the magnetic recording medium having no projections on the surface of the backcoat layer accompanying the thermal treatment. The magnetic recording medium thus obtained can be cut to a desired size using a cutter, a stamper, etc. before use.

VIII. Physical Properties

The saturation magnetic flux density of the magnetic layer of the magnetic recording medium used in the present invention is preferably 100 to 300 T·m (1,000 to 3,000 G). The coercive force (Hc) of the magnetic layer is preferably 143.3 to 318.4 kA/m (1,800 to 4,000 Oe), and more preferably 159.2 to 278.6 kA/m (2,000 to 3,500 Oe). It is preferable for the coercive force distribution to be narrow, and the SFD and SFDr are preferably 0.6 or less, and more preferably 0.2 or less.

The coefficient of friction, with respect to a head, of the magnetic recording medium used in the present invention is preferably 0.5 or less at a temperature of −10° C. to 40° C. and a humidity of 0% to 95%, and more preferably 0.3 or less. The electrostatic potential is preferably −500 V to +500 V. The modulus of elasticity of the magnetic layer at an elongation of 0.5% is preferably 0.98 to 19.6 GPa (100 to 2,000 Kg/mm²) in each direction within the plane, and the breaking strength is preferably 98 to 686 MPa (10 to 70 Kg/mm²); the modulus of elasticity of the magnetic recording medium is preferably 0.98 to 14.7 GPa (100 to 1,500 Kg/mm²) in each direction within the plane, the residual elongation is preferably 0.5% or less, and the thermal shrinkage at any temperature up to and including 100° C. is preferably 1% or less, more preferably 0.5% or less, and yet more preferably 0.1% or less.

The glass transition temperature of the magnetic layer (the maximum point of the loss modulus in a dynamic viscoelasticity measurement at 110 Hz) is preferably 50° C. to 180° C., and that of the non-magnetic layer is preferably 0° C. to 180° C. The loss modulus of elasticity is preferably in the range of 1×10⁷ to 8×10⁸ Pa (1×10⁸ to 8×10⁹ dyne/cm²), and the loss tangent is preferably 0.2 or less. When the loss tangent is too large, the problem of tackiness easily occurs. These thermal properties and mechanical properties are preferably substantially identical to within 10% in each direction in the plane of the medium.

The residual solvent in the magnetic layer is preferably 100 mg/m² or less, and more preferably 10 mg/m² or less. The porosity of the coating layer is preferably 30 vol % or less for both the non-magnetic layer and the magnetic layer, and more preferably 20 vol % or less. In order to achieve a high output, the porosity is preferably small, but there are cases in which a certain value should be maintained depending on the intended purpose. For example, in the case of disk media where repetitive use is considered to be important, a large porosity is often preferable from the point of view of storage stability.

The center plane average roughness Ra of the magnetic layer is preferably 4.0 nm or less, more preferably 3.0 nm or less, and yet more preferably 2.0 nm or less, when measured using a TOPO-3D digital optical profiler (manufactured by Wyko Corporation). The maximum height SRₘₐₓ of the magnetic layer is preferably 0.5 μm or less, the ten-point average roughness SRz is 0.3 μm or less, the center plane peak height SRp is 0.3 μm or less, the center plane valley depth SRv is 0.3 μm or less, the center plane area factor SSr is 20% to 80%, and the average wavelength Sλa is 5 to 300 μm. It is possible to set the number of surface projections on the magnetic layer having a size of 0.01 to 1 μm at any level in the range of 0 to 2,000 projections per 100(μm)², and by so doing the electromagnetic conversion characteristics and the coefficient of friction can be optimized, which is preferable. They can be controlled easily by controlling the surface properties of the support by means of a filler, the particle size and the amount of a powder added to the magnetic layer, and the shape of the roll surface in the calendering process. The curl is preferably within ±3 mm.

When the magnetic recording medium of the present invention has a non-magnetic layer and a magnetic layer, it can easily be anticipated that the physical properties of the non-magnetic layer and the magnetic layer can be varied according to the intended purpose. For example, the elastic modulus of the magnetic layer can be made high, thereby improving the storage stability, and at the same time the elastic modulus of the non-magnetic layer can be made lower than that of the magnetic layer, thereby improving the head contact of the magnetic recording medium.

A head used for playback of signals recorded magnetically on the magnetic recording medium of the present invention is not particularly limited, but an MR head is preferably used. When an MR head is used for playback of the magnetic recording medium of the present invention, the MR head is not particularly limited and, for example, a GMR head or a TMR head can be used. A head used for magnetic recording is not particularly limited, but it is preferable for the saturation magnetization to be 1.0 T or more, and preferably 1.5 T or more.

### EXAMPLES

The present invention is explained below more specifically with reference to examples. The components, proportions, procedures, orders, etc. described below can be modified as long as the spirit and scope of the present invention is maintained, and the examples below should not be construed as being limited thereto. ‘Parts’ in the examples denotes parts by weight unless otherwise specified.

Measurement Methods

1. Coating Smoothness

The number of projections having a size of 10 nm or greater was determined by scanning an area of 30 μm×30 μm using a Nanoscope II manufactured by Digital Instrument at a tunnel current of 10 nA and a bias voltage of 400 mV. The smoothness was expressed as a value relative to 100 for Comparative Example 1.

2. Electromagnetic Conversion Characteristics

A single frequency signal at 4.7 MHz was recorded using a DDS3 drive at an optimum recording current, and the playback output was measured. It was expressed as a value relative to 0 dB for Comparative Example 1.

3. SUS Contamination Resistance

Tape was made to slide repeatedly for 5,000 passes at 40° C. and 80% against an SUS guide pole used in a DDS3 drive with the magnetic layer surface in contact with the guide pole while applying a load of 100 g (T1) and pulling with a tension (T2) that gave 14 mm/sec, and the tape damage was evaluated using the ranking below.
Excellent: some scratches, but more areas in which there were no scratches.
Good: more scratched areas than unscratched areas.
Poor: magnetic layer completely peeled off.
   4. Storage Stability

The magnetic layer surface of tape stored at 60° C. and 90% RH for 60 days was placed in contact with a guide pole used in a DDS3 drive at 40° C. and 80% RH while applying a load of 50 g (T1), and the coefficient of friction of the magnetic surface against the guide pole was obtained from T2/T1 by pulling with a tension (T2) that gave 14 mm/sec. The measurement was repeated for 500 passes, and the coefficient of friction obtained in the 500th pass relative to that of the first path was determined.

Contamination on the guide pole after the measurement was investigated using a differential interference optical microscope, and evaluated using the ranking below.
Excellent: no contamination at all.
Good: some contamination, but more areas that were uncontaminated.
Poor: more contaminated areas than uncontaminated areas.

A reactor equipped with a reflux condenser and a stirrer was flushed with nitrogen and a polyol and a short chain diol having the compositions shown in Table 1 were dissolved in cyclohexanone under a flow of nitrogen at 60° C. to give a 30% solution. Dibutyltin dilaurate (60 ppm) was added thereto as a catalyst and the mixture was stirred for a further 15 minutes. A diisocyanate shown in Table 1 was added thereto, and the mixture was reacted at 90° C. for 6 hours while heating to give polyurethane resin solutions A to N.

The weight-average molecular weights of each of the polyurethanes thus obtained are given in Table 1.

The weight-average molecular weights of the polyurethanes were determined using DMF as a solvent with a polystyrene standard.

TABLE 1

| | | | | | | | | | | Bridged |
|---|---|---|---|---|---|---|---|---|---|---|
| | Starting material and composition Units: wt % | | | | | | | | | hydrocarbon or |
| | | | | | | | Diisocyanate | | Weight-average | spiro structure |
| Polyurethane | Polyol component | | Short chain diol component | | | | component | | molecular weight | content* |
| A | Polyester polyol A | 65.4 | Compound A | 3.7 | Compound F | 2.1 | Compound G | 28.8 | 72000 | 2.5 |
| B | Polyether polyol A | 56.4 | Compound A | 4.6 | Compound F | 2.6 | Compound G | 36.3 | 81000 | 1.0 |
| C | Polycarbonate polyol A | 62.7 | Compound A | 4.0 | Compound F | 2.3 | Compound G | 31.1 | 77000 | 1.8 |
| D | — | 0.0 | Compound B | 42.7 | Compound F | 3.9 | Compound G | 53.4 | 83000 | 2.2 |
| E | — | 0.0 | Compound C | 53.6 | Compound F | 3.1 | Compound G | 43.2 | 69000 | 1.8 |
| F | — | 0.0 | Compound D | 37.2 | Compound F | 4.3 | Compound G | 58.5 | 72000 | 2.4 |
| G | Polyester polyol B | 72.3 | Compound A | 0.0 | Compound F | 2.2 | Compound H | 25.4 | 71000 | 1.2 |
| H | Polyester polyol B | 71.3 | Compound A | 0.0 | Compound F | 2.2 | Compound I | 26.5 | 79000 | 1.2 |
| I | — | 0.0 | Compound D | 40.3 | Compound F | 4.6 | Compound I | 55.1 | 68000 | 5.1 |
| J | Polyester polyol B | 68.6 | Compound A | 0.0 | Compound F | 2.1 | Compound G | 29.3 | 78000 | 0.0 |
| K | Polyether polyol B | 68.7 | Compound A | 0.0 | Compound F | 2.1 | Compound G | 29.2 | 78000 | 0.0 |
| L | Polycarbonate polyol B | 68.7 | Compound A | 0.0 | Compound F | 2.1 | Compound G | 29.2 | 77000 | 0.0 |
| M | — | 0.0 | Compound A | 28.4 | Compound F | 4.9 | Compound G | 66.8 | 69000 | 0.0 |
| N | — | 0.0 | Compound E | 47.7 | Compound F | 3.5 | Compound G | 48.7 | 80000 | 0.0 |

*bridged hydrocarbon or spiro structure content is expressed as mmol/g.
Polyester polyol A: adipic acid/tricyclodecane dimethanol = 2/3 molar ratio polymer (molecular weight 794)
Polyester polyol B: adipic acid/3-methyl-1,5-pentanediol = 2/3 molar ratio polymer (molecular weight 574)
Polyether polyol A: propylene oxide (6 mol) adduct of tricyclodecane dimethanol (molecular weight 544)
Polyether polyol B: propylene oxide (6 mol) adduct of bisphenol A (molecular weight 576)
Polycarbonate polyol A: tricyclodecane dimethanol/1,6-hexanediol = 1/1 molar ratio polymer (molecular weight 706)
Polycarbonate polyol B: bisphenol A/1,6-hexanediol = 1/2 molar ratio polymer (molecular weight 516)

In Table 1, Compounds A to I denote the compounds below.
Compound A: neopentyl glycol
Compound B: tricyclodecane dimethanol
Compound C: spiroglycol
Compound D: norbornanediol
Compound E: hydrogenated bisphenol
Compound F: ethylene oxide adduct of Na sulfoisophthalate (molecular weight 356)
Compound G: 4,4′-diphenylmethane diisocyanate
Compound H: norbornane diisocyanate
Compound I: tricyclodecane diisocyanate
   The structures of Compounds A to I are shown below.

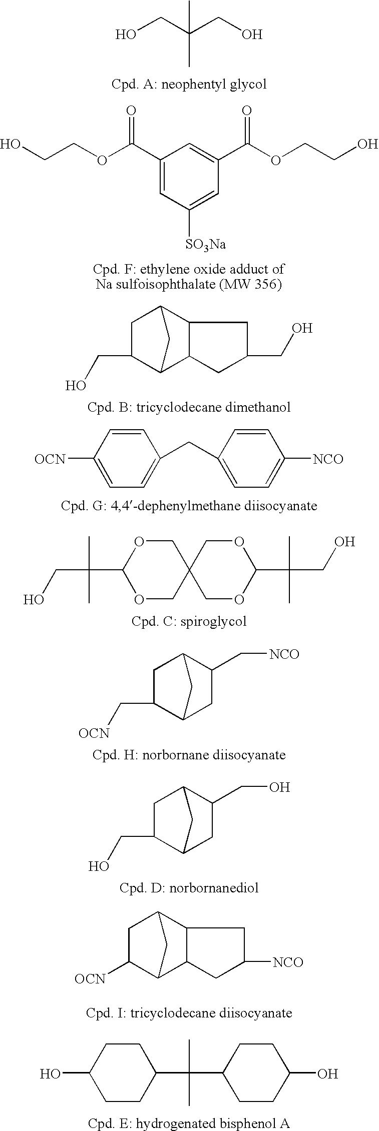

### Example 1

Preparation of magnetic coating solution

| | | |
|---|---|---|
| An acicular ferromagnetic alloy powder | 100 | parts |

(composition: Fe 92 atm %, Co 4 atm %, Ni 2 atm %, Al 2 atm %;
Hc 175 kA/m (2,200 Oe); S_{BET} 70 m²/g; major axis diameter 45 nm;
acicular ratio 3; σs 125 A · m²/kg (125 emu/g))
was ground in an open kneader for 10 minutes, and then kneaded for 60
minutes with

| | | |
|---|---|---|
| polyurethane resin solution A | 20 | parts (solids content) and |
| cyclohexanone | 60 | parts, |

following which

| | | |
|---|---|---|
| an abrasive (Al₂O₃, particle size | 2 | parts |
| 0.3 μm) | | |
| carbon black (particle size 40 μm) | 2 | parts, and |
| methyl ethyl ketone/toluene = 1/1 | 200 | parts |

were added, and the mixture was dispersed in a sand mill for 120 minutes.
To this were added

| | | |
|---|---|---|
| butyl stearate | 2 | parts |
| stearic acid | 1 | part, and |
| methyl ethyl ketone | 50 | parts, |

and after stirring the mixture for a further 20 minutes, it was filtered using
a filter having an average pore size of 1 μm to give a magnetic coating
solution.

Preparation of Magnetic Tape

A surface of a 7 μm thick polyethylene terephthalate support was coated by means of a wire-wound bar with a sulfonic acid-containing polyester resin as an adhesive layer so that the dry thickness would be 0.1 μm.

The magnetic coating solution obtained above was then applied by means of reverse roll so that the dry thickness would be 1.0 μm. Before the magnetic coating solution had dried, the non-magnetic support coated with the magnetic coating solution was subjected to magnetic field alignment using a 500 mT (5,000 G) Co magnet and a 400 mT (4,000 G) solenoid magnet. The coating was then subjected to a calender treatment employing a metal roll-metal roll-metal roll-metal roll-metal roll-metal roll-metal roll combination (speed 100 m/min, line pressure 300 kg/cm, temperature 90° C.) and then slit to a width of 3.8 mm to give a magnetic tape.

### Examples 2 to 15 and Comparative Examples 1 to 9

Magnetic tapes of Examples 2 to 14 and Comparative Examples 1 to 9 were prepared in the same manner as in Example 1 except that, instead of polyurethane resin A and the magnetic substance of Example 1, those shown in Table 2 were used.

The tabular ferromagnetic substance used in the Examples and Comparative Examples was a ferromagnetic hexagonal ferrite powder (composition Ba 100 mol, Fe 9.1 mol, Co 0.3 mol, Zn 0.6 mol; Hc 175 kA/m (2,200 Oe); S_{BET} 55 m²/g).

### Example 16

Preparation of Upper Layer Magnetic Coating Solution

The same magnetic coating solution as in Example 1 was used.

Preparation of lower layer non-magnetic coating solution

| | | |
|---|---|---|
| α-Fe₂O₃ (average particle size | 85 | parts |
| 0.15 μm, S_{BET} 52 m²/g, surface | | |
| treatment with Al₂O₃ and SiO₂, pH | | |
| 6.5 to 8.0) was ground in an open | | |
| kneader for 10 minutes, and then | | |
| kneaded for 60 minutes with | | |
| an addition compound of sodium | 7.5 | parts |
| hydroxyethylsulfonate with a | | |
| copolymer of vinyl chloride/vinyl | | |
| acetate/glycidyl methacrylate = | | |
| 86/9/5 (SO₃Na = 6 × 10⁻⁵ eq/g, | | |
| epoxy = 10⁻³ eq/g, Mw 30,000) | | |
| polyurethane resin A | 10 | parts (solids content), and |
| cyclohexanone | 60 | parts |
| following which | | |
| methyl ethyl ketone/ | 200 | parts |
| cyclohexanone = 6/4 | | |

was added, and the mixture was dispersed in a sand mill for 120 minutes.
To this were added

| | | |
|---|---|---|
| butyl stearate | 2 | parts |
| stearic acid | 1 | part, and |
| methyl ethyl ketone | 50 | parts, |

and after stirring the mixture for a further 20 minutes, it was filtered using
a filter having an average pore size of 1 μm to give a lower layer coating
solution.

Preparation of Magnetic Tape

A surface of a 7 μm thick polyethylene terephthalate support was coated by means of a wire-wound bar with a sulfonic acid-containing polyester resin as an adhesive layer so that the dry thickness would be 0.1 μm.

Using reverse roll simultaneous multilayer coating, the lower layer coating solution obtained above was then applied so that the dry thickness would be 1.5 μm, immediately followed by the upper layer magnetic coating solution, which was applied so that the dry thickness would be 0.1 μm. Before the magnetic coating solution had dried, the non-magnetic support coated with the magnetic coating solution was subjected to magnetic field alignment using a 500 mT (5,000 G) Co magnet and a 400 mT (4,000 G) solenoid magnet. The coating was then subjected to a calender treatment employing a metal roll-metal roll-metal roll-metal roll-metal roll-metal roll-metal roll combination (speed 100 m/min, line pressure 300 kg/cm, temperature 90° C.) and then slit to a width of 3.8 mm to give a magnetic tape.

### Example 17 and Comparative Examples 10 to 13

Magnetic tapes were prepared in the same manner as in Example 16 except that the polyurethane resin for the upper magnetic layer and the lower non-magnetic layer was changed to those shown in Table 2 and the upper layer magnetic substance was changed to those shown in Table 2.

The tabular ferromagnetic substance used in the Comparative Examples was a ferromagnetic hexagonal ferrite powder (composition Ba 100 mol, Fe 9.1 mol, Co 0.3 mol, Zn 0.6 mol; Hc 175 kA/m (2,200 Oe); S_{BET} 55 m²/g).

The types of ferromagnetic powder and polyurethane used in the Examples and Comparative Examples, and evaluation results for the magnetic tapes prepared above are given in Table 2.

TABLE 2

| | | | | | Electromagnetic | SUS | Storage stability | |
|---|---|---|---|---|---|---|---|---|
| | Poly- | Magnetic substance | | Smooth- | conversion | contamn. | | μ value |
| | urethane | Type/major axis length or plate size | | ness | characteristics | resistance | Contamn. | increase |
| Example 1 | A | Acicular ferromagnetic substance | 45 nm | 40 | 0.9 | Excellent | Excellent | 1.2 |
| Example 2 | B | Acicular ferromagnetic substance | 45 nm | 50 | 0.8 | Excellent | Excellent | 1.2 |
| Example 3 | C | Acicular ferromagnetic substance | 45 nm | 55 | 0.9 | Excellent | Excellent | 1.1 |
| Example 4 | D | Acicular ferromagnetic substance | 45 nm | 40 | 0.8 | Excellent | Excellent | 1.0 |
| Example 5 | E | Acicular ferromagnetic substance | 45 nm | 40 | 0.8 | Excellent | Excellent | 1.1 |
| Example 6 | F | Acicular ferromagnetic substance | 45 nm | 50 | 0.9 | Excellent | Excellent | 1.1 |
| Example 7 | G | Acicular ferromagnetic substance | 45 nm | 50 | 0.9 | Excellent | Excellent | 1.2 |
| Example 8 | H | Acicular ferromagnetic substance | 45 nm | 60 | 0.8 | Excellent | Excellent | 1.2 |
| Example 9 | I | Acicular ferromagnetic substance | 45 nm | 60 | 0.8 | Excellent | Excellent | 1.2 |
| Example 10 | A | Acicular ferromagnetic substance | 20 nm | 35 | 1.2 | Excellent | Excellent | 1.2 |
| Example 11 | D | Acicular ferromagnetic substance | 20 nm | 30 | 1.3 | Excellent | Excellent | 1.3 |
| Example 12 | A | Tabular ferromagnetic substance | 50 nm | 50 | 0.7 | Excellent | Excellent | 1.2 |
| Example 13 | D | Tabular ferromagnetic substance | 50 nm | 55 | 0.8 | Excellent | Excellent | 1.2 |
| Example 14 | A | Tabular ferromagnetic substance | 10 nm | 30 | 1.3 | Excellent | Excellent | 1.3 |
| Example 15 | D | Tabular ferromagnetic substance | 10 nm | 25 | 0.5 | Excellent | Excellent | 1.1 |
| Example 16 | A | Acicular ferromagnetic substance | 45 nm | 40 | 0.8 | Excellent | Excellent | 1.3 |
| Example 17 | D | Acicular ferromagnetic substance | 45 nm | 40 | 1.0 | Excellent | Excellent | 1.3 |
| Comp. Ex. 1 | J | Acicular ferromagnetic substance | 45 nm | 100 | 0.0 | Poor | Poor | 2.3 |
| Comp. Ex. 2 | K | Acicular ferromagnetic substance | 45 nm | 110 | −0.3 | Poor | Poor | 1.8 |
| Comp. Ex. 3 | L | Acicular ferromagnetic substance | 45 nm | 105 | −0.3 | Poor | Poor | 2.1 |
| Comp. Ex. 4 | M | Acicular ferromagnetic substance | 45 nm | 105 | 0.0 | Poor | Poor | 1.6 |
| Comp. Ex. 5 | N | Acicular ferromagnetic substance | 45 nm | 120 | −0.5 | Good | Poor | 1.5 |
| Comp. Ex. 6 | J | Tabular ferromagnetic substance | 50 nm | 85 | 0.2 | Poor | Poor | 2.2 |
| Comp. Ex. 7 | N | Tabular ferromagnetic substance | 50 nm | 95 | 0.2 | Good | Poor | 2.1 |
| Comp. Ex. 8 | A | Acicular ferromagnetic substance | 70 nm | 210 | −1.5 | Good | Poor | 2.2 |
| Comp. Ex. 9 | D | Tabular ferromagnetic substance | 70 nm | 250 | −1.4 | Good | Poor | 2.2 |
| Comp. Ex. 10 | J | Acicular ferromagnetic substance | 45 nm | 85 | 0.1 | Poor | Poor | 2.3 |
| Comp. Ex. 11 | N | Tabular ferromagnetic substance | 50 nm | 85 | 0.3 | Good | Poor | 2.5 |
| Comp. Ex. 12 | A | Acicular ferromagnetic substance | 70 nm | 78 | 0.3 | Good | Poor | 2.4 |
| Comp. Ex. 13 | D | Tabular ferromagnetic substance | 70 nm | 75 | 0.3 | Good | Poor | 2.3 |

1. A magnetic recording medium comprising:
a non-magnetic support; and
at least one magnetic layer provided on or above the non-magnetic support, the magnetic layer comprising a ferromagnetic powder dispersed in a binder;
the binder comprising a polyurethane resin having a bridged hydrocarbon structure or a spiro structure; and
the ferromagnetic powder comprising an acicular ferromagnetic substance having a major axis length of 20 to 50 nm or a tabular ferromagnetic substance having a plate size of 10 to 50 nm.

2. The magnetic recording medium according to claim 1, wherein the medium comprises at least one non-magnetic layer provided between the non-magnetic support and the magnetic layer, the non-magnetic layer comprising a non-magnetic powder dispersed in a binder, and the binder of the non-magnetic layer comprising a polyurethane resin having a bridged hydrocarbon structure or a spiro structure.

3. The magnetic recording medium according to claim 1, wherein the content of the bridged hydrocarbon structure or the spiro structure in the polyurethane resin is 1 to 5.5 mmol/g.

4. The magnetic recording medium according to claim 1, wherein the bridged hydrocarbon structure or the spiro structure is at least one structure selected from the group consisting of Formulae (1) to (3).

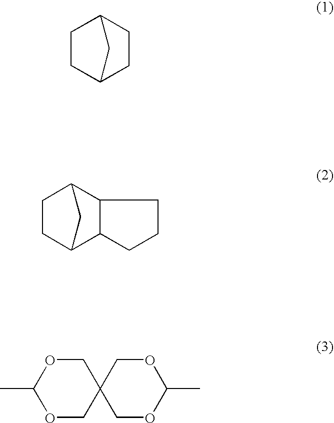

5. The magnetic recording medium according to claim 1, wherein the polyurethane resin has a weight-average molecular weight of 40,000 to 100,000.

6. The magnetic recording medium according to claim 1, wherein the polyurethane resin contains a polar group selected from the group consisting of —SO₃M, —OSO₃M, —PO₃M₂, and —COOM (M denotes a hydrogen atom, an alkali metal, or ammonium).

7. The magnetic recording medium according to claim 1, wherein the polyurethane resin is a polyurethane resin obtained by a reaction between a polyol and a polyisocyanate, and the polyol and/or the polyisocyanate has a bridged hydrocarbon structure or a spiro structure.

8. The magnetic recording medium according to claim 1, wherein the polyurethane resin is a polyurethane resin obtained by a reaction between a polyol, a polyisocyanate, and a short chain diol as a chain extending agent, and at least one of the polyol, the polyisocyanate, and the short chain diol has a bridged hydrocarbon structure or a spiro structure.

9. The magnetic recording medium according to claim 1, wherein the acicular ferromagnetic substance is a ferromagnetic metal powder.

10. The magnetic recording medium according to claim 9, wherein the ferromagnetic metal powder is a cobalt-containing ferromagnetic iron oxide or a cobalt-containing ferromagnetic alloy powder.

11. The magnetic recording medium according to claim 1, wherein the tabular ferromagnetic substance is a ferromagnetic hexagonal ferrite powder.

12. The magnetic recording medium according to claim 11, wherein the ferromagnetic hexagonal ferrite powder is selected from the group consisting of barium ferrite, strontium ferrite, lead ferrite, and calcium ferrite substituted derivatives and Co-substituted derivatives.

13. The magnetic recording medium according to claim 1, wherein the magnetic layer has a thickness of 0.01 to 0.10 μm.

14. The magnetic recording medium according to claim 2, wherein the non-magnetic layer has a thickness of 0.2 to 3.0 μm.
